(19) United States
(12) Patent Application Publication
(10) Pub. No.: US 2006/0198038 A1
(43) Pub. Date: Sep. 7, 2006

(54) Wiring for micromirror array lens

(75) Inventors: Sang Hyune Baek, Suwon (KR); Gyoung Il Cho, Seoul (KR); Cheong Soo Seo, Seoul (KR)

Correspondence Address: PARK LAW FIRM, 3255 WILSHIRE BLVD, SUITE 1110, LOS ANGELES, CA, 90010, US

(73) Assignees: STEREO DISPLAY, INC.; ANGSTROM, INC.

(21) Appl. No.: 11/072,296

(22) Filed: Mar. 4, 2005

(51) Int. Cl. G02B 5/08

(52) U.S. Cl. 359/851

(57) ABSTRACT

A micromirror array lens includes a micromirror lying in a micromirror layer, an electrode configured to displace the micromirror by electrostatic force, and a control wire coupled to the electrode and configured to supply voltage to the electrode to generate electrostatic force. In one embodiment, the control wire lies in a gap between the micromirror and another micromirror in the micromirror layer. In another embodiment, the control wires lie beneath the micromirror layer, such that the fill-factor of the micromirror array lens is optimized. In another embodiment, the micromirror array lens includes a passivation layer configured to provide electrical isolation between the electrode and the control wire. The advantages of the present invention include improved optical efficiency and accuracy by minimizing the voltage variation of electrode and control wire by each other and electrostatic force between control wire and micromirror.

### FIELD OF THE INVENTION

The present invention relates to micromirrors in general and more specifically to wiring for a micromirror array lens.

### BACKGROUND OF THE INVENTION

Micromirrors are used in various optical applications. FIG. 1 is a schematic diagram showing a prior art micromirror array lens. The micromirror array lens includes micromirrors configured to reflect light and control wires configured to supply voltage to electrodes under the micromirrors for the displacement of the micromirrors by electrostatic force.

Conventional micromirror array lens is described in J. Boyd and G. Cho, 2003, “Fast-response Variable Focusing Micromirror Array Lens,” Proceeding of SPIE Vol. 5055: 278-286. The invention works as a variable focal length lens, and consists of many micromirrors to reflect the light and actuating components to control positions of the micromirrors. Each micromirror has the same function as a mirror. By making all lights scattered from one point of an object have the same periodical phase and converge at one point of image plane, the conventional micromirror array works as a reflective focal length lens. In order to do this, the micromirrors were electrostatically controlled to have desired positions by actuating components. A diffraction-limited micromirror array lens is formed by controlling both one degree of freedom (DOF) translation and one degree of freedom (DOF) rotation of each micromirror. The micromirror with both one DOF translation and one DOF rotation has a complex mechanical structure, actuating components and coupled motion. Therefore, fabrication, accurate control, and large motions of the micromirror are difficult. A micromirror array lens with one DOF rotation of micromirrors has a much simple mechanical structure and actuating components. The micromirror array lens formed by the control of one DOF rotation has relatively larger aberration because the same phase condition is not satisfied. Even though the quality of the lens formed by control of one DOF rotation is lower than the lens formed by control of both one DOF rotation and one DOF translation, it can be used as a variable focal length lens such as an imaging lens with low quality or focusing lens because of advantages that its structure and control is much simpler than those of the lens with both one DOF rotation and one DOF translation.

The micromirror array lens can be formed by a polar array of the micromirrors. For the polar array, each micromirror has a fan shape to increase an effective reflective area, so that the optical efficiency increases. The optical efficiency of the micromirror array lens can be improved by locating a mechanical structure upholding micromirrors and the actuating components under micromirrors to increase an effective reflective area. Electric circuits to operate the micromirrors can be replaced with known semiconductor microelectronics technologies such as MOS and CMOS. Applying the microelectronics circuits under micromirror array, the effective reflective area can be increased by removing necessary area for electrode pads and wires.

As shown in FIG. 1, the control wires occupy space on the outer surface of the micromirror array lens, thereby degrading the fill-factor of the micromirror array lens. That is, the ratio of the area covered by the micromirrors with respect to the total area of the micromirror array lens is decreased. Thus, when there is movement of the micromirror array lens, there will be areas of the micromirror array lens that cannot reflect light, thereby decreasing the optical efficiency of the micromirror array lens.

Therefore, what is needed is optically efficient wiring for a micromirror array lens.

### SUMMARY OF INVENTION

The present invention addresses the problems of the prior art and provides optically efficient wiring for a micromirror array lens. The following six U.S. Patent Applications of the applicant describe variable focusing lenses having micromirrors, and an array of micromirror array lenses. U.S. patent application Ser. No. 10/855,554, which was filed on May 27, 2004, is for an invention entitled “Variable Focusing Lens Comprising Micromirrors with One Degree of Freedom Rotation.” U.S. patent application Ser. No. 10/855,715, which was filed on May 27, 2004, is for an invention entitled “Variable Focal Lens Comprising Micromirrors with Two Degrees of Freedom Rotation.” U.S. patent application Ser. No. 10/855,287, which was filed on May 27, 2004, is for an invention entitled “Variable Focal Lens Comprising Micromirrors with Two Degrees of Freedom Rotation and One Degree of Freedom Translation.” U.S. patent application Ser. No. 10/855,796, which was filed on May 28, 2004, is for an invention entitled “Variable Focal Lens Comprising Micromirrors with One Degree of Freedom Rotation and One Degree of Freedom Translation.” U.S. patent application Ser. No. 10/855,714, which was filed on May 28, 2004, is for an invention entitled “Array of Micromirror Array Lenses. U.S. patent application Ser. No. 10/857,280, which was filed on May 28, 2004, is for an invention entitled “Variable Focal Lens Comprising Micromirrors with One Degree of Freedom Translation.” The disclosures of these applications are incorporated by reference as if fully set forth herein.

The advantages of the present invention are achieved when the fill-factor of the micromirror array lens is increased, by locating control wiring so that it does not occupy space on the micromirror array lens that could be occupied by micromirrors. Further advantages of the present invention include improved optical efficiency and accuracy by minimizing the voltage variation of electrode and control wire by each other, and the electrostatic force between control wire and micromirror.

In one embodiment, a micromirror array lens includes a micromirror lying in a micromirror layer. The micromirror is configured to reflect light. The micromirror array lens further includes an electrode that is configured to displace the micromirror by electrostatic force. The electrode lies in an electrode layer and is communicatively coupled to the micromirror. A control wire is coupled to the electrode and is configured to supply voltage to the electrode to generate the electrostatic force. The control wire lies in a gap between the micromirror and another micromirror in the micromirror layer, such that the fill-factor of the micromirror array lens is optimized.

In another embodiment of the invention, the electrode layer is configured to lie beneath the micromirror layer. In an alternative embodiment, the micromirror array lens also includes a substrate layer lying beneath the electrode layer. The substrate layer provides a substrate surface to hold the micromirror array lens.

In still another embodiment of the invention, a micromirror array lens, includes a micromirror, lying in a micromirror layer, the micromirror is configured to reflect light. The micromirror array lens further includes an electrode configured to displace the micromirror by electrostatic force. The electrode lies in an electrode layer and is communicatively coupled to the micromirror. A control wire, coupled to the electrode, is configured to supply voltage to the electrode to generate the electrostatic force. A substrate layer lying beneath the electrode layer and a passivation layer lying between the electrode layer and the substrate layer, is configured to provide electrical isolation between the electrode and the control wire. The control wire lies under the passivation layer and the electrode layer such that a fill-factor of the micromirror array lens is optimized.

The fill-factor of the micromirror array lens is optimized when the electrode is configured to receive the control wire through a bottom surface of the electrode, thereby supplying control voltage from beneath the electrode and reducing space on the micromirror array lens.

The advantages of the present invention include improved optical efficiency and accuracy by reducing wiring influence. These and other features of the present invention will be described in more detail below in the detailed description of the invention and in conjunction with the following figures.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a schematic diagram showing a prior art micromirror array lens;

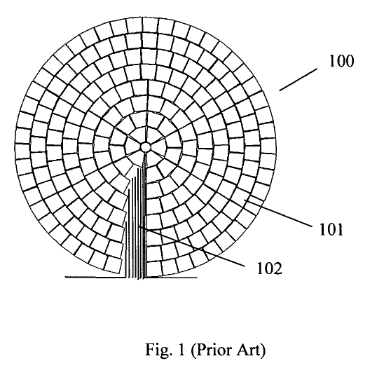

FIG. 2 is a schematic diagram showing a micromirror array lens with wiring placed in micromirror gaps, according to an embodiment of the invention;

FIG. 3 is a schematic diagram showing a micromirror array lens with wiring placed beneath micromirrors, according to another embodiment of the invention; and

FIG. 4 is a schematic diagram showing a micromirror array lens with wiring placed beneath an electrode layer and a passivation layer, according to another embodiment of the invention.

### DETAILED DESCRIPTION OF EMBODIMENTS

The present invention will now be described in detail with reference to a few embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

The present invention increases the fill-factor of a micromirror array lens, thereby increasing the lens' optical efficiency. By locating control wiring, such that it does not obstruct the micromirror array lens or occupy space on the micromirror layer that could be occupied by micromirrors, the optical efficiency is increased.

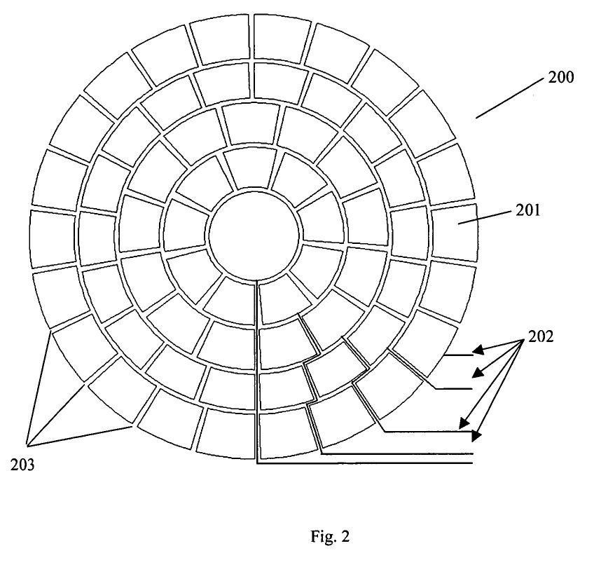

FIG. 2 is a schematic diagram showing a micromirror array lens 200 with wiring (i.e., control wires) 202 placed in micromirror gaps, also referred to as gaps, 203 between micromirrors 201, according to an embodiment of the invention. Because the control wires 202 are located in the micromirror gaps 203, there is no need to occupy areas on the micromirror array lens 200 that could be occupied by the micromirrors 201 with the control wires 202. That is, the fill-factor is increased, thereby increasing optical efficiency of the micromirror array lens 200. The fill-factor is the ratio of the surface area occupied by the micromirrors 201 to the overall surface area of the micromirror array lens 200. The surface area of the micromirror array lens 200 is the surface area of the ‘top’ layer of the micromirror array lens 200, where the micromirrors 201 may be located.

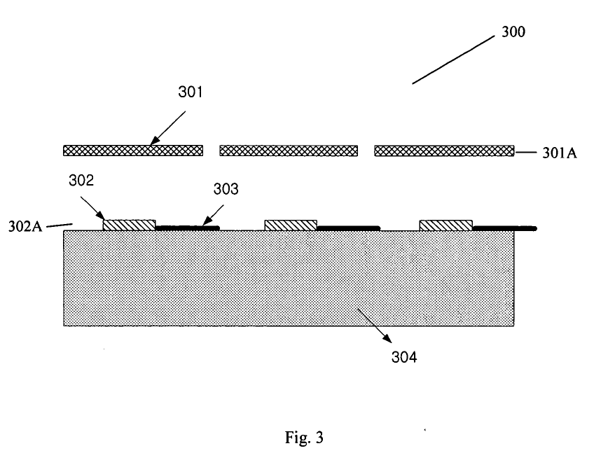

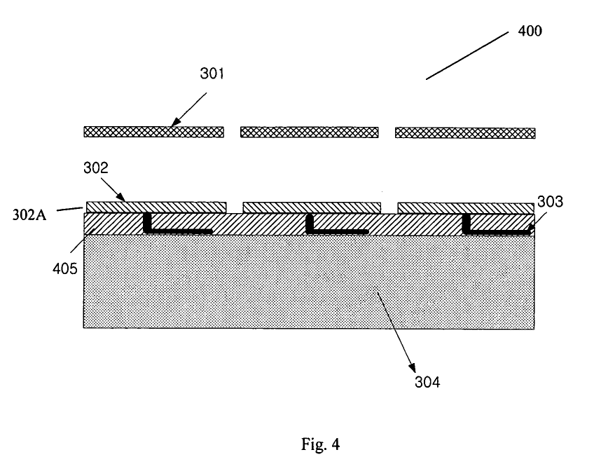

In one embodiment, as referenced in FIGS. 3-4, the micromirror array lens 200 includes the micromirror 201 lying in a micromirror layer, configured to reflect light. The micromirror array lens 200 also includes an electrode, lying in an electrode layer, communicatively coupled to the micromirror 201, configured to displace the micromirror 201 by electrostatic force. The micromirror array lens 200 also includes the control wires 202, coupled to the electrode, configured to supply voltage to the electrode to generate the electrostatic force. The control wires 202 lie in the gaps 203 between the micromirror 201 and another micromirror in the micromirror layer, such that a fill-factor of the micromirror array lens 200 is optimized.

The micromirror layer includes a plurality of micromirrors. That is, the micromirror layer includes the micromirror 201 and other micromirrors for example, another micromirror. For simplicity, the plurality of micromirrors in the micromirror layer is also referred to as micromirrors 201. Furthermore, although the electrode and the control wire may be referred to in singular, any number of electrodes and/or control wires is possible.

In one embodiment, the electrode layer lies beneath the micromirror layer. In another embodiment, the micromirror array lens 200 also includes a substrate layer (refer to FIGS. 3-4), lying beneath the electrode layer.

As shown in FIG. 2, due to placement of the micromirrors 201, locating the control wires 202 in the micromirror gaps 203 may require complex configurations of the control wires 202. This complication is addressed below with respect to FIGS. 3 and 4.

FIG. 3 is a schematic diagram showing a micromirror array lens 300 with wiring (control wires) 303, placed beneath micromirrors 301, according to another embodiment of the invention.

In the embodiment depicted in FIG. 3, the micromirror array lens 300 includes a micromirror 301, configured to reflect light. The micromirror 301 lies in a micromirror layer 301A. The micromirror array lens 300 also includes an electrode 302, communicatively coupled to the micromirror 301, configured to displace the micromirror 301 by electrostatic force. The electrode 302 lies in an electrode layer 302A. The micromirror array lens 300 also includes a control wire 303, coupled to the electrode 302, configured to supply voltage to the electrode 302 to generate the electrostatic force. The control wire 303 lies beneath the micromirror layer 301A, such that a fill-factor of the micromirror array lens is optimized.

In one embodiment, the electrode layer 302A lies beneath the micromirror layer 301A. In another embodiment, the micromirror array lens 300 also includes a substrate layer 304, lying beneath the electrode layer 302A. The substrate layer provides a substrate surface to hold the micromirror array lens. In another embodiment, the control wire 303 lies above of the substrate layer 304.

The embodiment described with reference to FIG. 3 may overcome the need for complex configurations of the control wires described with reference to FIG. 2, because the control wire 303 is located beneath the micromirror layer 301A, instead of in the micromirror gaps 203. However, if the control wire 303 is fabricated on the electrode layer 302A, the electrode area may be reduced because of the space required by the control wire 303. Furthermore, the control wire 303 may influence the displacement of the micromirror 301 by an electrical field generated by the control wire 303. This complication is addressed below with respect to FIG. 4.

FIG. 4 is a schematic diagram showing a micromirror array lens 400 with the wiring (i.e., control wires) 303 placed beneath the electrode layer 302A and a passivation layer 405, according to another embodiment of the invention.

In the embodiment depicted in FIG. 4, the micromirror array lens 400 includes the micromirror 301, lying in the micromirror layer 301A, configured to reflect light. The micromirror array lens 400 also includes an electrode 302, lying in the electrode layer 302A, communicatively coupled to the micromirror 301, and configured to displace the micromirror 301 by electrostatic force. The micromirror array lens 400 also includes the control wire 303, coupled to the electrode 302, configured to supply voltage to the electrode 302 to generate the electrostatic force. The micromirror array lens 400 also includes a substrate layer 304, lying beneath the electrode layer 302A. The micromirror array lens 400 further includes a passivation layer 405 lying between the electrode layer 302A and the substrate layer 304. The passivation layer is configured to provide electrical isolation between the electrode 302 and the control wire 303. The control wire 303 lies beneath the passivation layer 405, such that the electrode area can be maximized and the influence of electrical field generated by the control wire can be minimized.

The embodiment described with reference to FIG. 4 may overcome the complication described with reference to FIG. 3. By locating the control wire 303 beneath the electrode layer 302A, the influences of the control wire 303 on the displacement of the micromirror 301 may be reduced. Furthermore, the control wire 303 is located to go beneath the electrode. In this aspect of the invention, the control wire is coupled to the electrode bottom surface by going directly through the passivation layer and the electrode bottom surface. The control wire supply's voltage to control the micromirror. Many control wires and electrodes have different voltages to control many micromirrors. Because the control wires are located under the electrode, voltages of electrode and control wire are influenced by each other. To minimize the voltage variation, it is desirable that the control wires are located under an electrode having ground potential.

The advantages of the present invention include improved optical efficiency and accuracy by reducing wiring influence. While the invention has been shown and described with reference to different embodiments thereof, it will be appreciated by those skills in the art that variations in form, detail, compositions and operation may be made without departing from the spirit and scope of the invention as defined by the accompanying claims.

1-3. (canceled)

4. A micromirror array lens, comprising:
at least one micromirror, lying in a micromirror layer, configured to reflect light;
at least one electrode, lying in an electrode layer, communicatively coupled to the micromirror, configured to displace the micromirror by electrostatic force; and
at least one control wire, coupled to the electrode, configured to supply voltage to the electrode to generate the electrostatic force;
wherein, the control wire lies beneath the micromirror layer, such that a fill-factor of the micromirror array lens is optimized.

5. The micromirror array lens of claim 4, wherein the electrode layer lies beneath the micromirror layer.

6. The micromirror array lens of claim 5, further comprising a substrate layer, lying beneath the electrode layer, configured to hold the micromirror array lens.

7. The micromirror array lens of claim 6, wherein the control wire lies above of the substrate layer.

8-12. (canceled)

13. The micromirror array lens of claim 6, further comprises a passivation layer, lying between the electrode layer and the substrate layer, configured to provide electrical isolation between the electrode and the control wire.

14. The micromirror array lens of claim 4, further comprises a plurality of electrodes.

15. The micromirror array lens of claim 4, wherein the control wire lies in a gap between the micromirror and another micromirror.
